(19) United States
(12) Patent Application Publication
(10) Pub. No.: US 2007/0251350 A1
(43) Pub. Date: Nov. 1, 2007

(54) High Temperature and Vibration Joint Closure Composition and Method of Application

(76) Inventor: Henry H. Bryan III, Houston, TX (US)

Correspondence Address: LUNDEEN & DICKINSON, LLP, PO BOX 131144, HOUSTON, TX, 77219-1144, US

(21) Appl. No.: 11/380,922

(22) Filed: Apr. 29, 2006

(51) Int. Cl. C21B 13/00; B32B 5/16

(52) U.S. Cl. 75/300; 442/325

(57) ABSTRACT

The present invention relates to a resilient, non-rubberoid composition which can be cut to form an impenetrable barrier along a corrugated metal sheet joint to prevent egress of hot, noxious, gases from the interior of the building formed by such sheets. The joint closure material is permanently flexible and therefore resists cracking from vibration experienced in such environments. The method of inserting this material and sealing the joints consists of shaping the material, applying an elastomeric material to the surface of the seam to which a seal is to be made, applying the joint material and joining the two sheets with screws which penetrate both the sheets as well as the filler material. The use of elastomeric heat resistant material seals the entirety of the seam and prevents egress of the gases through the joint.

### BACKGROUND OF THE INVENTION

1. Field of Invention

The present invention relates to a composition and a method for installing same for sealing emission canopy housings; more specifically, to a resilient composition which is resistant to high temperature and vibration degradation to seal seams between corrugated sheeting used in electric arc and ladle metallurgical furnace (EAF and LMF) emission canopy housing construction to thereby prevent egress of noxious fumes and particulate matter (fugitive emissions) to the outside atmosphere.

2. Description of Related Art

In the steel industry, the need to contain, house and dispose of air-borne environmental contaminants commonly known as “fugitive emissions”, requires that the buildings housing such operations provide a long-lasting heat and vibration resistant seal along roof and ridge lines to prevent particulate matter and gases from escaping or entering through cracks or spaces between corrugated sheets and other flat sheets. A seal which can also stop smoke, toxic or corrosive gases and other fugitive emissions from escaping the building interior, while maintaining the integrity of the cover to prevent the ingress of outside weather elements (such as rain, snow, etc.) is highly advantageous since it reduces the release of said fugitive emissions and avoids the regulatory fines, levies or production limitations imposed as result of violations of both federal and state environmental agencies.

Current technology provides for a rippled rubber insert which is placed between the underlying sheet and the upper sheet to provide the seal for the joint between the two adjoining sheets. Over time, and given the harsh environment many of these installations experience, the rubber insert deteriorates or cracks allowing egress of hot vapors from the interior of the building.

The contamination contains hazardous gases or materials which are prohibited by governmental regulation from release and leaves unsightly residue on surrounding areas. Canopy Recovery and Bag House systems have long been the usual method of air-born contaminant collection in the steel industry and in other related industries offering melt operations as an intrinsic part of the process performed. Historical evidence indicates these methods are likely to fail to contain the hazardous materials if the seals along the building surface fail to contain the fumes generated. If left in an unsecured status, the buildings release of the emissions are readily observed by federal and state environmental protection agents or their assigns (such as plant or third-party environmental engineers) whose training specifically calls for the ability to “read” smoke and/or gas venting from any area of the structure not designed for a controlled release (such as a flue gas stack or “mono-vent” system.) The present invention eliminates escape of fugitive emissions from canopy housings thereby eliminating any uncontrolled escape of emissions and the subsequent residual markings along the exterior of the canopy or building, which would otherwise signal long-term release of said emissions and trigger increased governmental or regulatory scrutiny of the steel melt facility.

When corrugated roof and wall structures are constructed, edges where the corrugated sheets are joined must be sealed. As previously noted, the neoprene rubber blocks can dry out and crack when exposed to constant variations of hot temperatures, noxious fumes and vibration often found in most melt shops while in operation. When these cracks occur, the air-born contaminants trapped in the interior roof level of the canopy or the melt shop ceiling are pushed through the corrugated gaps and released directly into the atmosphere. This type of contamination leak is readily identifiable during the repetitive process of melting the steel in the furnace which produce copious amounts of smoky emissions (“heats”) and is further recognizable by evidence of the contaminants' visible leakage to the outside and scaring on the exterior surface of the building. If these leaks are not fixed, substantial regulatory fines and reduced production allowances may be imposed on the heat shop proprietor for the violations. In an attempt to resolve the problem, many steel producers are or have been injecting polyurethane foam (a common insulating material) in attempts to reduce the release of emissions along the seams, only to discover this solution is temporary at best, failing within a matter of weeks or a few months.

The present invention allows these corrugated seams to be sealed and to resist cracking and leakage for long periods of time, extending over a period of years. Since the closure material is impervious to heat, corrosive gases and resilient (and therefore incapable of being stressed from repeated vibration), the seal obtained by the product and method of the present invention provides a long-term solution to melt shop problems frequently experienced in this industry.

### SUMMARY OF INVENTION

The joint closure composition system for closing joints of the present invention comprises a resilient non-rubber material, such as a wool-like fiber from an amorphous fusion of silicon, calcium, magnesium, aluminum and iron or an insulating material made from attenuating droplets of alumina-silica or silica-magnesia from fibers of calcium silicate or kaolin clay, shaped to compressively fit an edge created by a joint of a first and a second sheet of metal, typically corrugated materials; an elastomeric material coating the exterior surface of the resilient filler material and the adjacent surface of the adjoining metal sheets; and, providing each sheet to be attached to the adjoining sheet with a plurality of screws inserted through the first metal sheet, traversing the filler material and an elastomeric material, to engage the second metal sheet thereby affixing the first and second sheets with a vapor impermeable, vibration and fire-resistant filler material. The elastomeric material can be water-based, fire and heat resistant, ultraviolet light resistant, and corrosive and salt-water resistant.

A method of insertion of the claimed vapor resistant joint closure material comprises the steps of shaping the filler material to form-fit a corrugated sheet to be joined to a second sheet; applying the water-based, fire-resistant elastomeric material to an inner periphery of the first sheet; applying a water-based, fire-resistant elastomeric material to the shaped filler material to be form fit; inserting the coated filler material into the gap formed between the first sheet and the second sheet to a position where the exterior surface of the filler material is flush with the edge of the joint; and, inserting a sheet metal screw into the first sheet to extend through the filler material and into the adjoining surface of the second sheet to secure the two sheets with the filler material to seal the joint between the sheets. Since the filler material has the consistency of wool, it can be readily cut by hand to form the appropriate seal and to adjust the seal to a variety of geometric shapes posed by the various building shapes and corrugation forms.

### BRIEF DESCRIPTION OF THE SEVERAL VIEWS OF THE DRAWINGS

FIG. 1a is a schematic representation of a cut length of ceramic fiber in preparation for insertion in a corrugated seam.

FIG. 1b is a cut length of ceramic fiber after shaping by scissors or other cutting means now ready for coating with the elastomeric material and insertion between two corrugated metal sheets.

FIG. 1c is an alternative cut length of ceramic fiber ready for coating to join a corrugated sheet with a flat metal sheet surface.

FIG. 2 is a schematic cross-sectional representation of the cut length of ceramic fiber inserted between two previously coated corrugated metal sheets.

FIG. 3 is a schematic representation of a completed assembly of the elastomeric material around a flashing on two metal sheet exterior surfaces of a melt shop.

### DETAILED DESCRIPTION OF THE INVENTION

Mineral wool, also known as mineral cotton, silicate cotton, stone wool, slag wool, rockwool, and rock wool, is an inorganic substance and has long been known as a material readily adaptable to insulation and fire resistance. Ceramic fibers made from attenuating droplets of alumina-silica or silica-magnesia from fibers of calcium silicate or kaolin clay are also insulative and fire-resistant. The present invention adapts mineral wool, ceramic fibers, or similar compounds which may be shaped to conform to corrugation ridges in a joint between such corrugated sheets to seal the joint and prevent egress of hot gases and particulate matter beyond the confines of the building into which such sealing is provided. Further references to ceramic fiber should be construed to cover not only ceramic fibers but other forms of material such as rock wool, and the like. These sealing materials are coated with a water-based elastomeric material from any suitable resinous emulsion thermoplastic material, such as—without limitation—acrylic elastomeric latex, acrylic modified polyvinyl emulsion, plasticized polyvinyl acetate latex polymers, plasticized polyvinyl ethylene latex polymers and plasticized polyvinyl chloride latex polymers. These may be enhanced for UV light protection by addition of titanium dioxide (TiO₂), by way of example. The water content can run from approximately 7% to 31% by weight of the total material and is required for the mixing of the elastomeric material to the enhanced additives and for application purposes to form a mastic material for coating the surfaces of the ceramic fiber insert and the adjoining metal sheets to be sealed. The blank form of mineral cotton or ceramic fiber is shown in FIG. 1a, which shows a length of said material sufficient to extend along a corrugated surface to be sealed. The length of the material may be varied to match the size of the seam to be sealed.

FIG. 1b shows a schematic representation of a cut length of ceramic fiber which conforms to the shape of the corrugated ridges on a corrugated metal building joint. All types of corrugated sheeting may be accommodated to the present invention such as wide and intermediate ribbed, corrugated wall panels and N-decking forms of corrugated materials, without departing from the spirit of scope of this invention. Heretofore, the gaps between a corrugated sheet and the underlying sheet were filled with a rubber gasket which was preformed and installed to block the gaps between one corrugated sheet and the adjoining sheet. If this type of rubber gasket is present when the new installation is to take place, the prior material must be removed by hand. The installer can then cut the ceramic fiber either by hand at the installation location or the ceramic fiber could be provided in pre-cut segments to speed up the installation. The ceramic fiber material is inserted into the gaps between the corrugated sheets after the sheets have been cleaned and after coating the adjacent surfaces with an elastomeric fire-retardant liquid material. The ceramic fiber is then inserted into the gap and a final coat of the elastomeric sealant is placed over the exterior edge of the gap and adjacent surfaces of the joint to seal the ceramic fiber completely in the joint. Finally, a sheet metal screw is inserted through the exterior corrugated sheet through the ceramic fiber and into the adjacent metal sheet to seal the joint. Screws are inserted evenly spaced over the entire seam to hold the corrugated sheet affixed to the ceramic fiber and adjoining sheet.

As previously noted, FIG. 1a shows a cut length of ceramic fiber 100 prior to shaping. FIG. 1b shows a length of shaped ceramic fiber 100 which conforms to the shape of a corrugated ridge on a corrugated metal building joint having peaks 110 and valleys 120 formed by cutting or removing a portion of the ceramic fiber in a regular oscillating pattern. Heretofore, the gaps between a corrugated sheet and the underlying sheet were filled with a rubber gasket which was preformed in uniform pattern and then field installed to block the gaps between one corrugated sheet and an adjoining second corrugated sheet. While these rubber gap sealers worked temporarily, constant exposure to the heat and vibration of the industrial applications such as melt shops and similar environments caused the rubber gaskets to dry and crack. Once the cracking started, hot gases and particulates matter are normally released into the environment causing serious pollution around the heavy industrial plants.

FIG. 1c shows an alternative form of ceramic fiber filler precut to be placed between a corrugated sheet and an adjacent flat surfaced sheet for sealing purposes. Other forms consistent with the variety of corrugated metal sheets may be formed with this material without departing from the spirit of this invention.

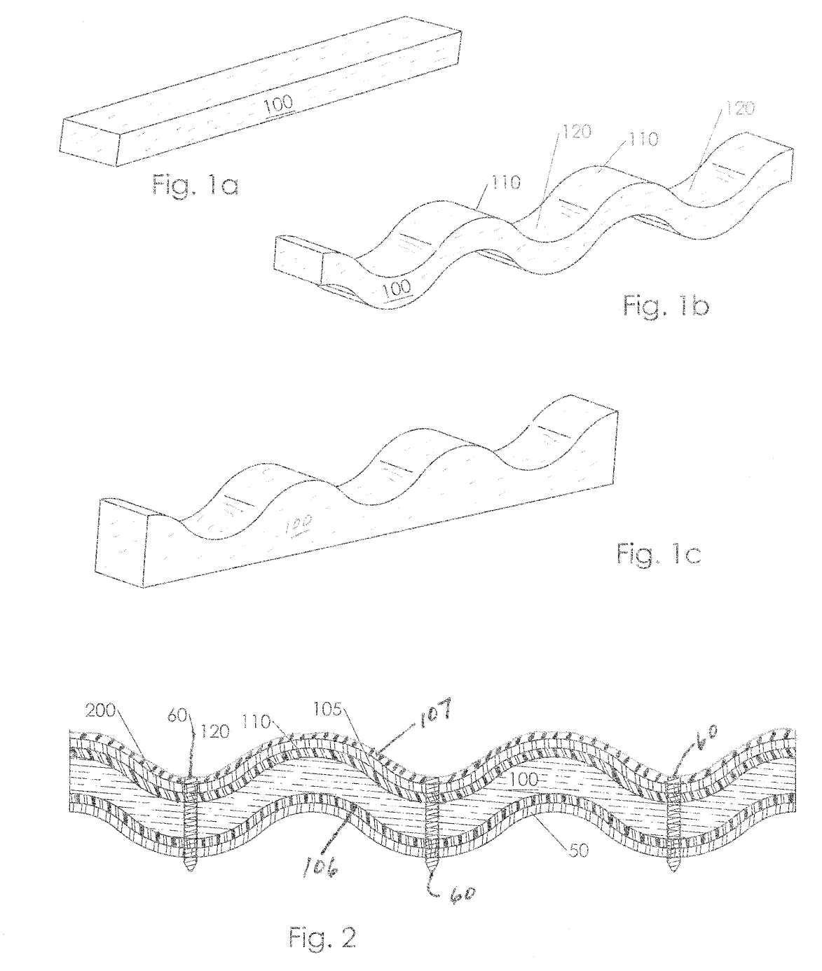

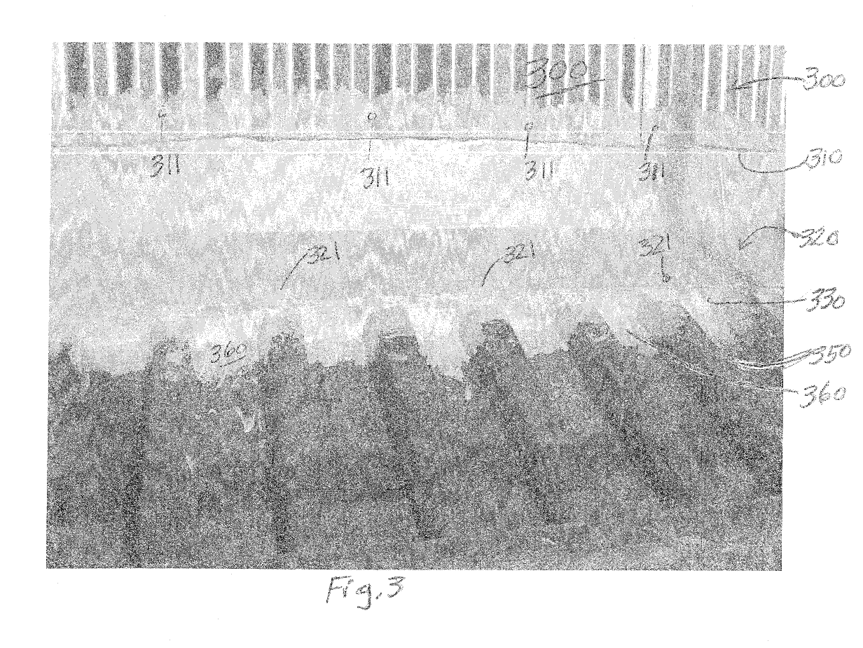

If this rubber type of gasket is present when the new installation takes place, the prior rubber material must be removed. The installer then cuts the ceramic fiber 100 either at the installation location or the ceramic fiber 100 could be provided in pre-cut segments to speed up the installation. As more clearly shown in FIG. 2, the ceramic fiber material is inserted into the gaps between the corrugated sheets 50 and 200 after the sheets have been cleaned and after coating the adjacent surfaces with an elastomeric fire-retardant liquid material on both the upper edge 105 and the lower edge 106 of the ceramic fiber 100 metal sheet seam 50, 200. The ceramic fiber length 100 is then inserted into the gap and a sheet metal screw 60 is inserted through the exterior corrugated sheet through the ceramic fiber and into the adjacent metal sheet to seal the joint. Finally, a covering coat of an elastomeric sealant 107 is placed over an exterior edge of the gap and adjacent surfaces of the joint to seal the ceramic fiber completely in the joint. Screws 60 are inserted evenly spaced over the entire seam to hold the corrugated sheet affixed to the ceramic fiber 100 and adjoining sheet 50. The screws can also be unevenly spaced and do not have to be along the entire seam. The seal thus accomplished by this material and technique withstands constant high temperature changes and differences, while permitting slight movement to damp vibration caused by expansive gases and machinery from breaking the seal. For example, in a melt shop canopy, hot gases can exceed 200° F., while exterior temperatures may range from −30° F. in winter months to higher than 120° F. during the summer months. Constant vibration from the buffeting of the canopy by the hot gases and machinery used in the foundry cause less pliable material to crack and split.

FIG. 2 also shows the arrangement of the ceramic fiber insert 100 between a first corrugated sheet 200 and a second corrugated sheet 50. Each sheet is coated with a water based elastomeric fire-resistant coating 105, 106 and the ceramic fiber insert is likewise coated. This coating process not only assures sealing between the ceramic fiber and the two adjacent corrugated metal sheets, but also creates a fire-resistant barrier along the adjoining sheets which is impermeable to hot gases and pollution thereby preventing egress of such polluting factors from under the enclosed roof surface. Since both the interior surface and the exterior surface are coated, the action of rain and wind cannot readily cause deterioration of the joint to open the joint to the elements and premature failure. The sheet metal screws 60 inserted at intervals into the first corrugated sheet through the coated ceramic fiber and into the second corrugated sheet are tightened to form a permanent seal along the seam. The application of the elastomeric material or mastic in this manner creates an adhesive, yet flexible, bond with the mating corrugated surfaces, which can last for years in the abusive environment of the foundry.

FIG. 3 shows a completed installation of the elastomeric material 330 in the interstices of the lower corrugated sheet 350. Flashing 320 overlays the lower sheet 350 and is inserted under upper corrugated sheet 300. Additional elastomeric material 310 is inserted in the upper seam between the upper sheet 300 and the flashing 320. Similarly, elastomeric material 330 coating the ceramic fiber is inserted in the gaps created between the lower sheet 350 and the flashing 320 after preparation of the surface by the application of the elastomeric coating material on each surface prior to affixing one to the other with appropriate sheet metal screws at 311 and 321.

Occasionally, fitting the insulation material around particular geometries of building joints may be required, but most often regular cuts will provide adequate insulation along the entire seam to be treated. The insulation material can be cut to fit any combination of flat and/or corrugated surfaces.

An alternative method of installation can be accomplished by cutting the ceramic fiber in blocks which are inserted in the valleys of each corrugated sheet after preparing the surface with a coat of elastomeric material. The ceramic fiber will bind to the freshly coated surface because of the inherent tackiness of the material prior to complete setting of the material in the air. After installation of the blocks in the valleys 360 such as shown in FIG. 3, a continuous strip of ceramic fiber can then be placed over the previously installed blocks and covered with the elastomeric material. The overlaying flashing 320 can then be installed over the continuous strip of ceramic fiber and secured through the underlying ceramic fiber strip and blocks to the corrugated decking by screws 321. The foregoing seam seals each corrugated sheet shown in FIG. 3 to each other with a flexible and heat resistant seal which will prevent the egress of hot, noxious fumes and particulate matter from the canopy of the EAF and LMF system.

Although only a few exemplary embodiments of this invention have been described in detail above, those skilled in the art can readily appreciate that many modifications are possible in the exemplary embodiments without materially departing from the novel teachings and advantages of this invention. Accordingly, all such modifications are intended to be included within the scope of this invention as defined in the following claims. It is the express intention of the applicant not to invoke 35 U.S.C. §112, paragraph 6 for any limitations of any of the claims herein, except for those in which the claim expressly uses the words “means for” together with an associated function.

What is claimed is:

1. A composition system for closing and sealing joints comprising:
a resilient material shaped to compressively fit an edge created by a joint of a first and a second sheet of metal;
an elastomeric material coating the exterior surface of the resilient filler material and the adjacent surface of the metal sheets; and,
one or more screws inserted through the first metal sheet traversing the filler material and elastomeric material to engage the second metal sheet to join the first and second sheets with a vibration, vapor and fire-resistant filler material.

2. The composition system of claim 1 wherein the resilient material is a wool-like fiber from an amorphous fusion of one or more of the following elements: silicon, calcium, magnesium, aluminum and iron.

3. The composition system of claim 1 wherein the resilient material is an insulating material made from attenuating droplets of alumina-silica or silica-magnesia from fibers of calcium silicate or kaolin clay.

4. The composition system of claim 1 wherein the elastomeric material is water-based.

5. The composition system of claim 1 wherein the elastomeric material is fire resistant.

6. The composition system of claim 1 wherein the elastomeric material is heat resistant.

7. The composition system of claim 1 wherein the elastomeric material is vibration resistant.

8. The composition system of claim 1 wherein the elastomeric material is UV light resistant.

9. The composition system of claim 1 wherein the elastomeric material is salt-water resistant.

10. A method of insertion of a heat and vibration resistant joint closure material comprising the steps of:
shaping a filler material to form-fit a corrugated sheet to be joined to a second sheet;
applying a water-based, fire-resistant elastomeric material to an inner periphery of the first sheet;
applying a water-based, fire-resistant elastomeric material to the shaped filler material to be form fit; and,
inserting the coated filler material into the gap formed between the first sheet and the second sheet to a position where the exterior surface of the filler material is flush with the edge of the joint.

11. The method of claim 10 further comprising the step of inserting one or more sheet metal screws into the first sheet to extend through the filler material and into the adjoining surface of the second sheet to secure the two sheets with the filler material to seal the joint between the sheets.
